(19) United States
(12) Patent Application Publication
(10) Pub. No.: US 2026/0065561 A1
(43) Pub. Date: Mar. 5, 2026

(54) SYSTEMS AND METHODS FOR USER-GENERATED HOLOGRAPHIC AVATARS

(71) Applicant: 2wai Inc., Bal Harbour, FL (US)

(72) Inventors: Russell Geyser, Los Angeles, CA (US); Alex Finden, Encinitas, CA (US); Mason Geyser, West Hills, CA (US); Jonathan Knapper, Aberdeen (GB); James Robert Pyers, New River, AZ (US); Gary Shoefield, Beverly Hills, CA (US); Calum David Webster Worthy, Victoria (CA)

(73) Assignee: 2wai Inc., Bal Harbour, FL (US)

(21) Appl. No.: 19/319,083

(22) Filed: Sep. 4, 2025

Related U.S. Application Data
(60) Provisional application No. 63/690,372, filed on Sep. 4, 2024.
(60) Provisional application No. 63/804,943, filed on May 13, 2025.

(51) Int. Cl. G06T 13/20; G06T 13/40

(52) U.S. Cl. CPC G06T 13/205; G06T 13/40

(57) ABSTRACT

Systems and methods for user-generated holographic avatars are disclosed herein. The systems and methods may include receiving, via a computing system, at least one of video data and audio data of a user; inputting, via the computing system, the video data and/or audio data to an AI model, wherein the AI model may be configured to stitch one or more motions captured in the video data, synchronize lip movements captured in the video data with the audio data, and synthesize expressions based on the video data and/or audio data; generating, by the AI model via the computing system, a holographic avatar based on the video data and/or audio data; and storing, via the computing system, avatar creation metadata based on the generation of the holographic avatar in a block of a blockchain.

### CROSS-REFERENCE TO RELATED APPLICATIONS

This application claims priority to U.S. Provisional Application No. 63/690,372, filed Sep. 4, 2024, and U.S. Provisional Application No. 63/804,943, filed May 13, 2025, which are hereby incorporated by reference in their entireties.

### FIELD

The present disclosure is generally directed to systems and methods for user-generated holographic avatars.

### BACKGROUND

With the advancement of Artificial Intelligence (AI) technology, avatars are increasingly being used in virtual meetings, education, retail, and entertainment. Current avatar platforms offer cartoonish or stylized 3D representations with limited realism, limited customization, and limited security features.

### SUMMARY

In some embodiments, a method is provided. The method may include receiving, via a computing system, at least one of video data and audio data of a user. The method may further include inputting, via the computing system, the video data and/or audio data to an AI model. The AI model may be configured to stitch one or more motions captured in the video data, synchronize lip movements captured in the video data with the audio data, and synthesize expressions based on the video data and/or audio data. The method may further include generating, by the AI model via the computing system, a holographic avatar based on the video data and/or audio data. The method may further include storing, via the computing system, avatar creation metadata based on the generation of the holographic avatar in a block of a blockchain.

In some embodiments, a system is provided. The system may include a non-transitory storage medium storing computer program instructions and a processor configured to execute the computer program instructions to cause operations. The operations may include receiving, via a computing system, at least one of video data and audio data of a user. The operations may further include inputting, via the computing system, the video data and/or audio data to an AI model. The AI model may be configured to stitch one or more motions captured in the video data, synchronize lip movements captured in the video data with the audio data, and synthesize expressions based on the video data and/or audio data. The operations may further include generating, by the AI model via the computing system, a holographic avatar based on the video data and/or audio data. The operations may further include storing, via the computing system, avatar creation metadata based on the generation of the holographic avatar in a block of a blockchain.

In some embodiments, a non-transitory storage medium storing computer program instructions is provided. The computer program instructions when executed may cause a computing system to perform operations. The operations may include receiving, via a computing system, at least one of video data and audio data of a user. The operations may further include inputting, via the computing system, the video data and/or audio data to an AI model. The AI model may be configured to stitch one or more motions captured in the video data, synchronize lip movements captured in the video data with the audio data, and synthesize expressions based on the video data and/or audio data. The operations may further include generating, by the AI model via the computing system, a holographic avatar based on the video data and/or audio data. The operations may further include storing, via the computing system, avatar creation metadata based on the generation of the holographic avatar in a block of a blockchain.

### BRIEF DESCRIPTION OF THE FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 depicts a block diagram of an illustrative computing environment, in accordance with example embodiments.

FIG. 2 depicts a diagram of an illustrative user capture interface module, in accordance with example embodiments.

FIG. 3 depicts a diagram of an illustrative identity verification module, in accordance with example embodiments.

FIG. 4 depicts a diagram of an illustrative deployment and integration module, in accordance with example embodiments.

FIG. 5 depicts a diagram of an illustrative avatar generation pipeline module, in accordance with example embodiments.

FIG. 6 depicts a diagram of an illustrative customization module, in accordance with example embodiments.

FIG. 7 depicts a diagram of an illustrative quality assurance and learning module, in accordance with example embodiments.

FIG. 8 depicts a diagram of an illustrative avatar animation system module, in accordance with example embodiments.

FIG. 9 depicts a diagram of an illustrative conversation flow management module, in accordance with example embodiments.

FIG. 10 depicts a flowchart of an illustrative method, in accordance with example embodiments.

FIG. 11 depicts a block diagram of an example computing device, in accordance with example embodiments.

The features of the present disclosure will become more apparent from the detailed description set forth below when taken in conjunction with the drawings, in which like reference characters identify corresponding elements throughout. In the drawings, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The present disclosure is generally directed to systems and methods for user-generated holographic avatars. In particular, the present disclosure is directed to generating holographic avatars based on individual users and deploying the holographic avatars in various settings.

As avatars are increasingly used in virtual meetings, education, retail, and entertainment, there is a growing demand for self-generated, secure, lifelike avatar systems accessible via mobile devices. Such a system can provide a user the ability to generate a life-like avatar of themselves using a common device while also relying on the security of the avatar. With a secure avatar, the likelihood of others using the avatar to create unlicensed content, such as deepfakes, is significantly lowered as the documented rights reside with the creator. The resulting avatars may be configured to be interoperable across platforms including games, social media, augmented reality (AR), virtual reality (VR), extended reality (XR), and/or metaverse environments.

The present disclosure relates to systems and methods for generating, verifying, and deploying photorealistic or stylized holographic avatars in digital environments. The disclosed technology may enable users to create avatars based on captured video and audio, while ensuring authenticity, identity protection, and cross-platform integration.

The avatar generation system may include modules for pre-processing, machine learning-based reconstruction, pose extraction, and audio spectrum analysis. Captured video may be processed to extract key poses and expressions, which may be mapped to emotions, sentiments, and/or base points for smooth transitions. Voice sampling may be analyzed to extract phonemes, which may be contextually mapped to facilitate accurate speech synthesis and lip synchronization.

To ensure identity verification and prevent unauthorized use, the system may be configured to incorporate a blockchain-based verification module. The verification module may be configured to store avatar creation metadata on-chain, track modifications, and validate ownership using biometric data, avatar hashes, and blockchain signatures. A Know-Your-Customer (KYC) process may support secure authentication and may generate a unique authorization token for each verified avatar.

Avatars may be formatted and deployed through an integration module supporting export to web, mobile, and AR/VR platforms. The system may include one or more APIs and/or developer kits to enable third-party implementation and support cross-platform transitions with consistent avatar state and continuity.

The quality assurance and learning module may be configured to perform real-time avatar validation and learning using machine learning techniques. By comparing generated avatars against original user inputs and annotated datasets, the system may be configured to improve accuracy and fidelity over time.

This architecture may be configured to support a range of applications, including entertainment, education, telepresence, identity authentication, digital media, or enterprise use, offering scalable, secure, and personalized holographic avatar deployment.

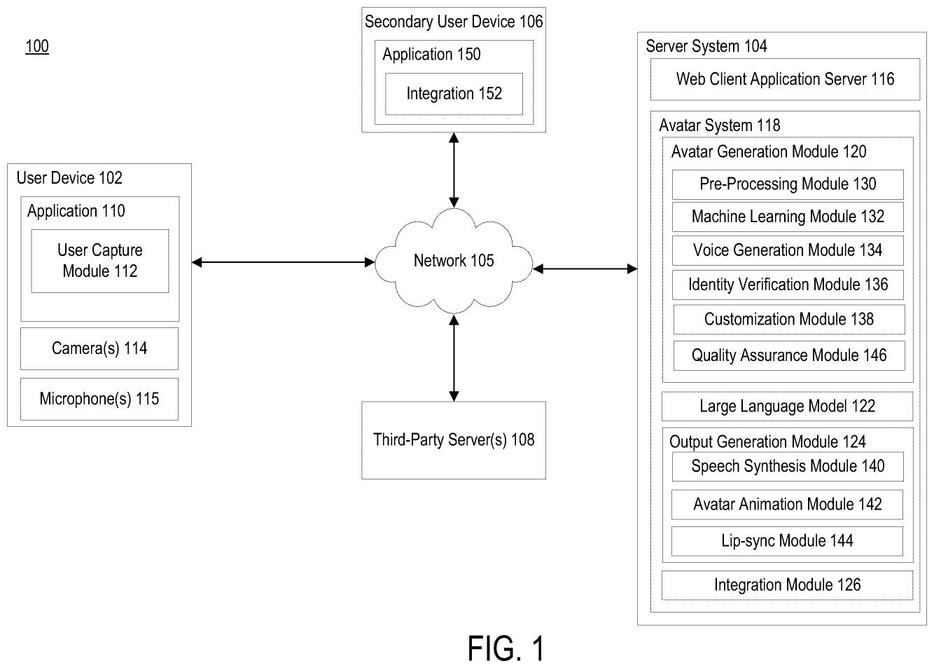

FIG. 1 is a block diagram of an illustrative computing environment, in accordance with example embodiments. Computing environment 100 may include user device 102, server system 104, and secondary user device 106 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be the Internet, a private data network, virtual private network using a public network and/or other suitable connection(s) that enables components in computing environment 100 to send and receive information between the components of computing environment 100.

User device 102 may be operated by a user. User device 102 may be representative of a mobile device, a tablet, a desktop computer, or any computing system having the capabilities described herein. User device 102 may include an application 110 executing thereon. Application 110 may be representative of an application associated with server system 104. For example, application 110 may be representative of an application that generates a three-dimensional avatar of an individual, such as the user of user device 102. Application 110 may be configured to allow the user to manage their use of the three-dimensional avatar. In some embodiments, application 110 may be a standalone application associated with server system 104, such as a mobile application, tablet application, desktop application, or, more generally, a software application affiliated with an entity associated with server system 104. In some embodiments, application 110 may be representative of a web browser configured to communicate with server system 104, such that an end user may gain access to avatar system 118 of server system 104 via a web browser. More generally, application 110 may be configured to provide an interface between user device 102 and server system 104 for the purpose of allowing a user to access functionality of the avatar system of server system 104. Via application 110, a user can create an account with avatar system 118, which allows the end user to create and manage a three-dimensional avatar that looks, behaves, sounds, and more generally, interacts, like the user.

Application 110 may include user capture module 112. User capture module 112 may be comprised of one or more software modules. The one or more software modules may be collections of code, or instructions stored on a media (e.g., memory of user device 102) that represent a series of machine instructions (e.g., program code) that implements one or more algorithmic steps. The machine instructions may be the actual computer code the processor of user device 102 interprets to implement the instructions or, alternatively, may be a higher level of coding of the instructions that may be interpreted to obtain the actual computer code. In some embodiments, the one or more software modules may also include one or more hardware components. One or more aspects of an example algorithm may be performed by the hardware components (e.g., circuitry) itself, rather than as a result of the instructions.

User capture module 112 may be configured to interface with one or more cameras 114 associated with the user device 102 to capture video data of the user. In some embodiments, one or more cameras 114 may be integrated with user device 102. In some embodiments, one or more cameras 114 may be external to user device 102. In some embodiments, user capture module 112 may be configured to interface with one or more microphones 115 associated with user device 102 to capture audio data of the user. In some embodiments, one or more microphones 115 may be integrated with user device 102. In some embodiments, one or more microphones 115 may be external to user device 102.

In some embodiments, user capture module 112 may provide real-time or near real-time instructions to the user for capturing a high-quality video of themselves for the purpose of generating a three-dimensional avatar that looks like the user. In some embodiments, user capture module 112 may be configured to prompt the user to capture a video of themselves that is of minimum length (e.g., three minutes). In some embodiments, user capture module 112 may prompt the user to perform one or more movements while recording the video of themselves. For example, user capture module 112 may prompt the user to turn their heads or bodies, raise their arms or hands, and the like. In some embodiments, user capture module 112 may prompt the user to speak to the camera, such that user capture module 112 can capture the sound of the user's voice, as well as the manner in which the user moves their lips or emotes while speaking.

In some embodiments, during the avatar creation process, application 110 may further prompt the user to provide non-video input for the creation of their avatar. For example, application 110 may prompt the end user to answer a series of questions that can be used to train an artificial intelligence system to interact with other users in a manner consistent with the user's actual interactions.

In some embodiments, application 110 may further prompt the user to customize their avatar. For example, user capture module 112 may be configured to generate a local preview of their avatar such that an end user can customize the appearance and behavior of their avatar. In some embodiments, appearance customizations may include, but are not limited to, accurate representation of user's clothing from capture session, optional special effects for adding 3D clothing or accessories, product placement overlay capabilities for monetization, ad-funded content integration, and/or customizable 3D backgrounds reflecting user's preferences or environment. In some embodiments, behavior customizations may include, but are not limited to, memory capabilities (e.g., the ability to remember names and details of interactions), visual recognition (e.g., identifying people and objects via device camera), multilingual support (e.g., ability to communicate in multiple languages), personality adjustment (e.g., option to modify base answers shaping avatar's personality), and/or skill set expansion (e.g., ability to add or enhance specific capabilities based on user needs).

Server system 104 may be representative of one or more servers configured to communicate with one or more user devices, such as user device 102 and secondary user device 106. Server system 104 may include web client application server 116 and avatar system 118. Avatar system 118 may be configured to generate and manage avatars for end users. As shown, avatar system 118 may include avatar generation module 120, large language model 122, output generation module 124, and integration module 126. Each of avatar generation module 120, large language model 122, output generation module 124, and integration module 126 may be comprised of one or more software modules. The one or more software modules may be collections of code, or instructions stored on a media (e.g., memory of server system 104) that represent a series of machine instructions (e.g., program code) that implements one or more algorithmic steps. The machine instructions may be the actual computer code the processor of server system 104 interprets to implement the instructions or, alternatively, may be a higher level of coding of the instructions that may be interpreted to obtain the actual computer code. The one or more software modules may also include one or more hardware components. One or more aspects of an example algorithm may be performed by the hardware components (e.g., circuitry) itself, rather than as a result of the instructions.

Avatar generation module 120 may be configured to generate an avatar corresponding to an individual based on at least the captured video of the user. Avatar generation module 120 may include pre-processing module 130, machine learning module 132, voice generation module 134, identity verification module 136, customization module 138 and quality assurance and learning module 146.

Pre-processing module 130 may be configured to receive the video and audio generated by user capture module 112 at user device 102. Pre-processing module 130 may include one or more algorithms for removing background information from the uploaded video. By removing the background information from the uploaded video, pre-processing module 130 may effectively isolate the user within the video, which may assist machine learning module 132 in generating an avatar corresponding to the user. In some embodiments, for example, the background removal algorithm may be a customized version of the Segment Anything Model (SAM) to extract the user from the background across every frame of the capture module video. This approach may ensure high-quality segmentation and clean separation of the subject from the surrounding environment. Pre-processing module 130 may include one or more algorithms for extracting poses of the user, facial recognition, facial feature mapping, voice sampling, and/or audio spectrum analysis.

Machine learning module 132 may be configured to generate an avatar of the user based at least on the uploaded video of the user. In some embodiments, machine learning module 132 may further be configured to generate the avatar of the user based on the non-video data provided by the user, such as, but not limited to, audio information and information associated with the appearance and/or behavior of their avatar. In operation, the video data and the non-video data may be provided to a machine learning model of machine learning module 132 to generate, as output, an avatar that looks, behaves, sounds, and interacts like the user. In some embodiments, the machine learning model utilized by machine learning module 132 may be a generative-type model, such as, but not limited to a generative adversarial network (GAN). In some embodiments, the machine learning model utilized by machine learning module 132 may be representative of a generative diffusion model. In those embodiments in which GANs are used over other types of models, such as diffusion models, the benefit of doing so may be one of cost-effectiveness. For example, by using a GAN model, the approach proves to be significantly less expensive for ongoing generation and running of avatars compared to alternatives like diffusion models, although, as discussed above, diffusion models could alternatively be used. In some embodiments, Unreal Engine or Unity Engine may be used to generate stylized characters.

The machine learning model implemented by machine learning module 132 may be trained to generate avatars that are reflective of the look and behavior of their users based on a training process. In some embodiments, the training process is a supervised training process in which the machine learning model is trained to generate an avatar of a user based on a training data set that includes example videos of users and their corresponding avatars. Through this process, the machine learning model learns relationships between the input data (e.g., videos of users) and the output data (e.g., corresponding avatars). The training process may continue until the machine learning model reaches a threshold level of accuracy.

For GANs, the training process may be slightly different due to the underlying architecture of these types of models. For example, GANs typically include two networks: a generator network and a discriminator network. The generator network and the discriminator network undergo an adversarial process in which the generator attempts to generate output data that is accurate enough to trick the discriminator into thinking the output data from the generator is real data versus fake or generated data. During this process, the generator network is trained to generate more accurate outputs that may be capable of tricking the discriminator network into thinking the output is actual data. Further, the discriminator network may also be trained to better decipher between the artificially generated data and the real data. In the context of this particular use case, the generator network may be trained to generate avatars based on the input video data and the discriminator may be trained to determine whether the input received is a generated avatar or an actual video of the user.

As output from machine learning model, avatar generation module 120 may receive an avatar of a user that may be deployed and manipulated by components of avatar system 118 as described in further detail below.

Voice generation module 134 may be configured to analyze and clone the voice of the user from the audio data. In some embodiments, voice generation module 134 may include one or more algorithms or machine learning models that receives, as input, the audio data uploaded by the user and generates, as output, characteristics of the user's voice. In some embodiments, for example, voice generation module 134 may use the 11labs (11L) API for the voice generation process. In some embodiments, for example, voice generation module 134 may implement an open-source solution, such as, for example, the Coqui framework, for more customized voice synthesis. By identifying the characteristics of the user's voice, subsequent modules (described below) may create output for the avatar by applying the characteristics to conform the sound of the avatar's speech to that of the user.

Identity verification module 136 may be configured to employ a blockchain-based verification system to ensure that deepfakes or unauthorized avatars are not generated. Identity verification module 136 may be configured to receive an avatar from avatar generation module 120 along with avatar creation metadata and store at least the avatar creation metadata in a block of a blockchain. Any changes made to the avatar may be tracked by storing in or broadcasting to the blockchain. Identity verification module 136 may be configured such that if an unauthorized party attempts to edit and/or use the avatar, the blockchain will not recognize the party and prevent the editing and use of the avatar. Identity verification module 136 may be configured to verify user identity via Know Your Customer (KYC). In some embodiments, avatar system 118 may permit transferring ownership of the whole or any part of the generated avatar, including skins, movements, and expressions. Identity verification module 136 may be configured to reassign ownership authorizations to follow the transferred ownership of the avatar.

Customization module 138 may be configured to customize the generated avatar. Customization module 138 may allow for personalization or styling of the avatar. In some embodiments, customization module 138 may be configured to change one or more of accessories, hair styles, or clothing of the avatar. Machine learning module 132 may integrate a chosen accessory, hair style, and/or piece of clothing onto the avatar such that it appears seamless.

Once generated, the user's avatar may be stored in a database or storage location associated with server system 104. In this manner, multiple copies of the user's avatar may be generated such that the user's avatar may be able to exist in multiple places at a given time, thus providing the effect of the physical user existing in multiple places at one time.

Quality assurance and learning module 146 may be configured to analyze the generated avatar. Quality assurance and learning module 146 may compare the generated avatar to the captured video data to determine the quality of the generated avatar. In some embodiments, quality assurance and learning module 146 may be configured to dynamically improve the quality of the avatar and/or avatar generation based on the results of the determination. Quality assurance and learning module 146 may utilize machine learning module 132 for further training and fine-tuning and/or may be configured to fine-tune itself.

Output generation module 124 may be configured to generate output to be conveyed via the avatar. In some embodiments, output generation module 124 may be configured to generate output to be conveyed via the avatar based on one of more prompts received from user device 102. For example, as discussed above, once the user's avatar is generated, the user's avatar may be deployed in various applications to essentially act as a stand-in for the user. Using a simple example, the user's avatar may act as a stand in for the user during a video conferencing session. As such, the user's avatar needs to be able to receive input from other individuals, understand the input, and generate an output that conforms to that of the user. Output generation module 124 may include various modules to assist with this process.

In some embodiments, output generation module 124 may generate a response to a prompt directed towards the avatar by interfacing with large language model 122. Large language model 122 may be representative of one or more large language models affiliated with server system 104 or external to server system 104 (e.g., ChatGPT, Claude, Llama, etc.). In operation, output generation module 124 may receive a prompt directed to the avatar. In some embodiments, the prompt may be a voice prompt. In the case that the prompt is a voice prompt, output generation module 124 may convert the audio into a text-based format and may provide the text of the audio to large language model 122 for generating a response. For example, the text of the audio may act as the prompt to large language model 122 for generating an output. In some embodiments, output generation module 124 may provide additional context to large language model 122 to conform the output to the user's characteristics. For example, as additional context to the prompt, output generation module 124 may provide large language model 122 with the non-video information related to the behavior of the user. In some embodiments, large language model 122 may be able to handle a variety of language inputs and generate, as output, a variety of language outputs.

Once the response for the avatar is generated, output generation module 124 may cause the avatar to deliver the response. For example, output generation module 124 may generate an audible response, via speech synthesis module 140, based on the output from large language model 122 applying the characteristics of the user's voice, as identified by voice generation module 134, to the audio. In this manner, output generation module 124 may conform the sound of the avatar's speech to that of the user.

In some embodiments, output generation module 124 may further include avatar animation module 142 and lip-sync module 144. Avatar animation module 142 may be configured to select one or more gestures for the avatar from a gesture library stored in a memory of server system 104. The gesture library may include one or more gestures captured of the user by user capture module 112. Avatar animation module 142 may be configured to select gestures based on the generated response such that the gestures may be coordinated with the generated response based on characteristics of the user. Lip-sync module 144 may be configured to animate the lips of the avatar based on the output generated by output generation module 124 and/or large language model 122. In some embodiments, lip-sync module 144 may apply lip movement characteristics learned by machine learning module 132 during the avatar generation process. In this manner, the user's avatar may appear to both sound like the user and also move their lips and gesture like the user.

In some embodiments, lip-sync module 144 may use the Wav2Lip framework as a foundation to animate the lips of the avatar based on the output generated by output generation module 124 and/or large language model 122. In some embodiments, Wav2Lip may be customized for real time generation process. In some embodiments, the process may include input processing in which lip-sync module 144 may take the generated audio (speech) and the avatar's base video as inputs. Lip-sync module 144 may utilize the Wav2Lip model to extract relevant features from both the audio and video inputs. Based on the audio features, Wav2Lip may predict the corresponding lip movements. Based on the real-time customizations, Wav2Lip may process the output in real-time to reduce latency and improve the overall efficiency of the system. Lip-sync module 144 may then apply the predicted lip movements to the avatar's face, creating a synchronized video output. In some embodiments, lip-sync module 144 may fine-tune the output by making continuous adjustments to ensure smooth and natural-looking lip movements that match the audio precisely. This approach allows for highly accurate and responsive lip-syncing, crucial for creating believable and engaging avatar interactions in real-time applications.

Integration module 126 may be configured to manage one or more third party integrations for deployment of a user's avatar. For example, integration module 126 may provide the generated output of the user's avatar to one or more third party systems (e.g., Apple FaceTime, Zoom, Google Meet, Tinder, etc.). For example, avatar system 118 may create and store a base avatar for each user. For real-time interactions, instructions may be received on how to animate the avatar, any ad hoc text generation is processed by the large language model 122, decisions about which pre-generated response to use (from a vector database) may be made, and animation instructions are sent to user device 102, server system 104, and/or secondary user device 106. To optimize for cost and performance, one or more steps or functionalities described above may be performed on user device 102 and/or secondary user device 106, while reserving cloud resources (e.g., resources of server system 104) for complex computations and decision-making. This approach allows for efficient, responsive avatar interactions while balancing the load between cloud and local resources. Integration module 126 may be configured to enable avatars to be projected into a physical space using one or more of AR glasses, smartphone apps, or such like.

As shown, computing environment 100 may further include secondary user devices 106 and one or more third party servers 108. Secondary user devices 106 may be representative of user devices that are configured to interact with an avatar generated by avatar system 118. As shown, secondary user devices 106 may include application 150. Application 150 may be representative of a third-party application associated with one or more third party servers 108. Exemplary third-party applications may include, but are not limited to, FaceTime from Apple, Zoom from Zoom Video Communications, Teams from Microsoft, Tinder from Match Group, and the like.

Application 150 may include integration 152. Integration 152 may be representative of a script or software module that is configured to interface with integration module 126 of server system 104. In this manner, integration 152 may manage the deployment of the user's avatar for communication with secondary user device 106. For example, integration 152 may be configured to provide relay voice or text prompts from secondary user device 106 to avatar system 118 for processing. Similarly, integration 152 may be configured to surface responses generated by avatar system 118 to users of secondary user device 106 within application 150.

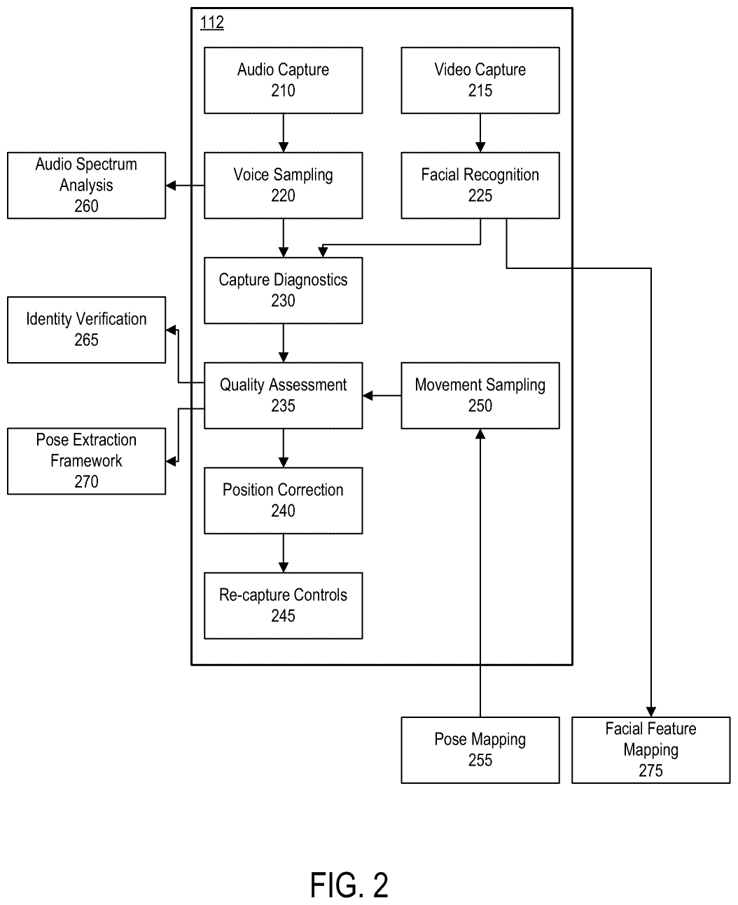

FIG. 2 is a diagram of an illustrative user capture module 112 in accordance with example embodiments. The user capture module 112 may be configured for audio capture 210 and video capture 215. User capture module 112 may utilize user capture module 112 in capturing the audio and video. The captured audio may be sampled via voice sampling 220. The voice sampling 220 information may be communicated to avatar generation module 120 for audio spectrum analysis 260. User capture module 112 may be configured to conduct facial recognition 225 on the captured video. The facial recognition 225 information may be communicated to avatar generation module 120 for facial feature mapping 275. User capture module 112 may be configured to perform capture diagnostics 230 on the voice sampling 220 and facial recognition 225. Capture diagnostics 230 may perform a quality assessment 235 on the voice sampling 220, facial recognition 225 and movement sampling 250. Movement sampling 250 may be generated from pose mapping 255 performed by avatar generation module 120.

Based on the result of the quality assessment 235, user capture module 112 may determine a position correction 240 is required. If a position correction 240 is required, user capture module 112 may initiate re-capture controls 245 to re-capture audio and video of the user via audio capture 210 and video capture 215. If position correction is not required, the captured information may be communicated to a pose extraction framework 270 via user capture module 112. User capture module 112 may be configured to communicate identity verification 265 to verify the identity of the captured audio and video.

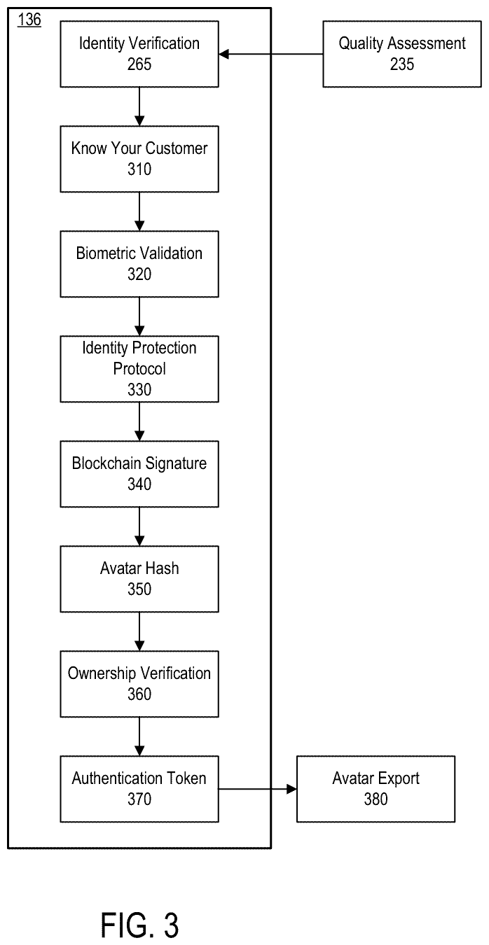

FIG. 3 is a diagram of an illustrative identity verification module 136, in accordance with example embodiments. Identity verification module 136 may include a KYC module 310. KYC module 310 may be configured to perform biometric validation 320 to verify the identity of the subject of the captured video and audio. Identity verification module 136 may include an identity protection protocol 330. Identity protection protocol 330 may include a blockchain signature 340, avatar hash 350, and ownership verification 360. Identity protection protocol 330 may be configured to verify the identity of the subject by comparing the captured video and audio with a known avatar hash of the user using blockchain signature 340. Identity protection protocol 330 may be configured to verify ownership based on a blockchain record of ownership of the avatar. When the identity has been verified, identity verification module 136 may be configured to generate an authentication token 370 to show that the avatar has been authenticated. Thus, identity verification module 136 may be configured to ensure integrity of the avatar, prevent deepfake misuse of the avatar, and allow traceable ownership verification of the avatar across platforms. Identity verification module 136 may communicate authentication token 370 to avatar export 380 for deployment and integration.

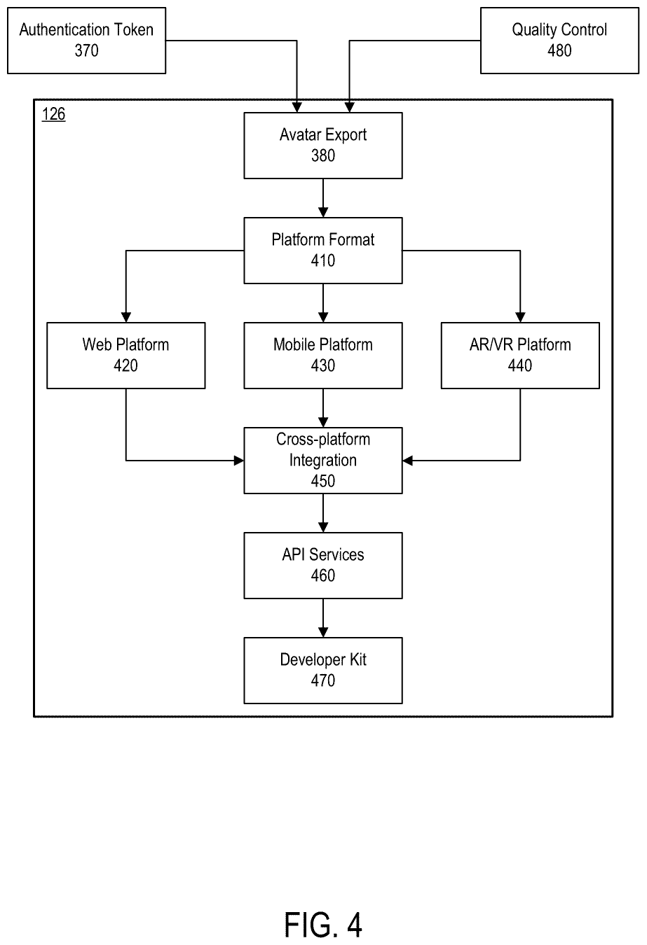

FIG. 4 is a diagram of an illustrative integration module 126, in accordance with example embodiments. The integration module 126 may be configured to deploy and/or integrate the avatar into various platforms. Integration module 126 may include avatar export 380. Avatar export 380 may be configured to format the avatar for different platforms via platform format module 410. The platforms may include a web platform 420, a mobile platform 430, and/or an AV/VR platform 440. Integration module 126 may be configured to include cross-platform integration 450. Cross-platform integration 450 may be configured to integrate across any number of platforms and even transition from one platform to another. Integration module 126 may be configured to provide application programing interface (API) services 460. API services 460 may include one or more developer kits 470. Developer kits 470 may be configured to enable one or more third party servers 108 to embed avatar system 118 directly into their applications and services. Developer kits 470 may provide platform-specific software development kits (SDKs) and/or API access enabling formatting and deployment of avatars via platform format module 410. Developer kits 470 may be configured to facilitate cross-platform integration 450 such that avatars can transition between platforms.

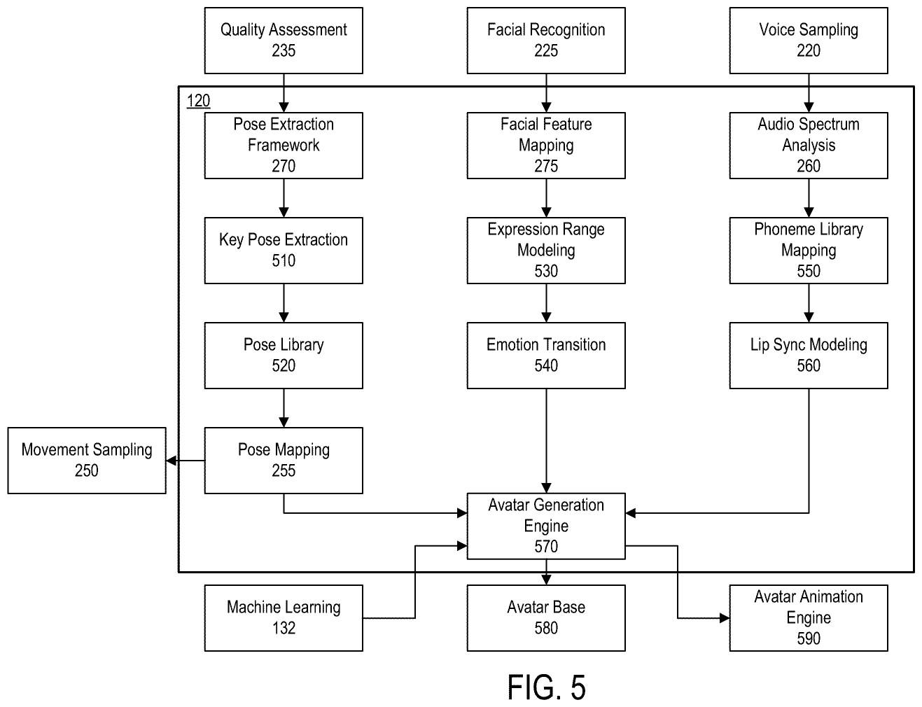

FIG. 5 is a diagram of an illustrative avatar generation module 120, in accordance with example embodiments. Avatar generation module 120 may utilize one or more of pre-processing module 130 or machine learning module 132 to generate an avatar. Avatar generation module 120 may include a pose extraction framework 270. Pose extraction framework 270 may be configured for key pose extraction 510 based on the video capture 215 information of the user. Extracted poses may be added to a pose library 520 which may be located in a memory in avatar system 118 and/or user device 102.

The poses in pose library 520 may be mapped to one or more of emotion, sentiment, base points, gesture-intent, interaction state, or scene context. Base points may be at a beginning or an end of an avatar movement to aid in smooth transitions between poses. Gesture-intent mapping may include mapping specific movements to certain keywords. For example, if the word “Yay!” is mapped to a gesture of both hands in the air and “Yay!” is included in the generated response, avatar animation module 142 may animate the avatar to put both hands in the air when “Yay!” is spoken. Interaction state mapping may include poses mapped to interaction states. For example, a pose of sitting may be mapped to an idle state such that when the avatar is in an idle state, the avatar is sitting. As a further example, a pose of standing may be mapped to a listening state such that when the avatar is in a listening state, the avatar is standing. As a further example, a pose of walking may be mapped to an active state such that when the avatar is in an active state, the avatar may be walking. This may allow for the avatar to walk like the user providing a more realistic avatar. Scene context mapping may include mapping certain poses to different scenes. For example, a pose of sitting may be the idle pose for a library scene while a pose of standing may be the idle pose for a garden scene.

Avatar generation module 120 may be configured for facial feature mapping 275. Facial feature mapping 275 may include expression range modeling 530 to map certain facial features to one or more facial expressions. Expression range modeling 530 may be configured to provide emotion transition 540 to provide for the avatar transitioning between emotions expressed in facial expressions.

Avatar generation module 120 may be configured to perform audio spectrum analysis 260. Based on the voice sampling 220 provided by user capture module 112, audio spectrum analysis 260 may extract phonemes of the user from the way they speak. The extracted phonemes may be added to a phoneme mapping library 550 which may include phonemes mapped with context of different words. In some embodiments, phoneme mapping library 550 may include one or more of emotionally expressive phoneme sets, language/dialect variations, or speaker-specific patterns.

The emotionally expressive phoneme sets may include phonemes mapped to one or more of tone or sentiment. The language/dialect variations may include phonemes mapped to certain letters and/or combinations of letters such that the avatar may speak like the user. In some embodiments, the language/dialect variations may be mapped based on a context of the phoneme within words. For example, a phoneme of rolling the letter “r” may be based on the context of which word the “r” is in and where the “r” is in the word. Speaker-specific patterns may include one or more inflection patterns or rhythm patterns to provide nuanced synthesis. Pre-processing module 130 may be configured to recognize patterns in the inflection and/or rhythm of the user's speech and map the patterns to one or more phonemes and/or words.

The phoneme mappings may allow the avatar to speak like the user with any accents or speech characteristics the user may have. Based on the separate phonemes and video of the user speaking, avatar generation module 120 may be configured to model connections between the phonemes and the captured video to allow the avatar to lip sync with the words being spoken to provide a hyper-realistic avatar.

The pose mapping 255, emotion transition 540, and lip sync modeling 560 may be input to an avatar generation engine 570 to generate an avatar corresponding to the user. Avatar generation engine 570 may utilize machine learning module 132 to generate the avatar. As each of the poses, facial expressions, and lip movements are generated from the video captured of the user, the avatar may act and look like the user. The likeness may be hyper-realistic such that the avatar animation may appear to be a video of the user. The avatar generated by avatar generation engine 570 may be output as the avatar base 580. Avatar generation module 120 may be configured to communicate the avatar to avatar animation module 142 to generate the animation of the avatar.

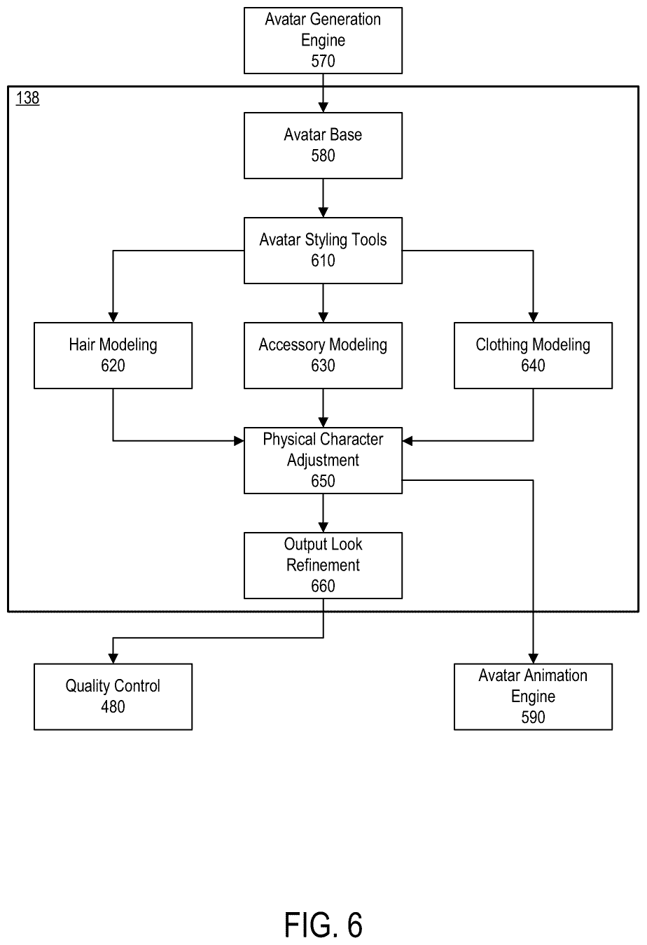

FIG. 6 is a diagram of an illustrative customization module 138, in accordance with example embodiments. Customization module 138 may be configured to receive an avatar base 580 from avatar generation engine 570. Customization module 138 may be configured to provide styling via avatar styling tool 610 and character adjustment via physical character adjustment 650. Avatar styling tool 610 may be configured to enable one or more of hair modeling 620, accessory modeling 630, or clothing modeling 640.

Hair modeling 620 may be configured to dynamically change the hair style of the avatar. For example, a user may choose a hair style to apply to the avatar from one or more hair styles stored in a hair style library. The hair style library may be stored in memory of avatar system 118. In some embodiments, the user may capture one or more of their own hair styles to be stored in the hair style library. In some embodiments, avatar system 118 may include a hair style library including hair styles not captured from the user. For example, the hair style library may include a predetermined list of hair styles. In some embodiments, the user may purchase one or more avatar hair styles. For example, the user may purchase a hairstyle from a virtual shop. The hair style may be added to the hair style library enabling the user to add the hair style to the avatar.

Accessory modeling 630 may be configured to dynamically change accessories of the avatar. Changing accessories may include any change in the accessories of the avatar, for example, adding accessories, removing accessories, replacing accessories, and the like. Accessory modeling 630 may be configured to access an accessory library. The accessory library may be stored in memory of avatar system 118. In some embodiments, the user may capture one or more of their own accessories to be stored in the accessory library. In some embodiments, avatar system 118 may include an accessory library including accessories not captured from the user. For example, accessory library may include a predetermined list of accessories. In some embodiments, the user may purchase one or more avatar accessories. For example, the user may purchase a virtual handbag from a virtual shop. The virtual handbag may be added to accessory library enabling the user to add the virtual handbag to the avatar.

Clothing modeling 640 may be configured to dynamically change clothing of the avatar. Changing clothing may include any change in the clothing of the avatar, for example, adding pieces of clothing, removing pieces of clothing, replacing pieces of clothing, or the like. Clothing modeling 640 may be configured to access a clothing library. The clothing library may be stored in memory of avatar system 118. In some embodiments, the user may capture one or more of their own pieces of clothing to be stored in the clothing library. In some embodiments, avatar system 118 may include a clothing library including clothing not captured from the user. For example, clothing library may include a predetermined list of pieces of clothing. In some embodiments, the user may purchase one or more avatar pieces of clothing. For example, the user may purchase a virtual fur coat from a virtual shop. The virtual fur coat may be added to clothing library enabling the user to add the virtual fur coat to the avatar.

Physical character adjustment 650 may be configured to implement any styling chosen via hair modeling 620, accessory modeling 630, and/or clothing modeling 640. For example, if the user chooses a hair style, an accessory, and a piece of clothing to include on their avatar, physical character adjustment 650 may adjust the avatar accordingly to include the chosen hair style, accessory, and piece of clothing. Customization module 138 may be configured to refine the look of the avatar after the physical character adjustment 650 via output look refinement 660. Output look refinement 660 may utilize machine learning module 132 to refine the look of the avatar. Customization module 138 may be configured to communicate the avatar to one or more of quality assurance and learning module 146 or avatar animation module 142.

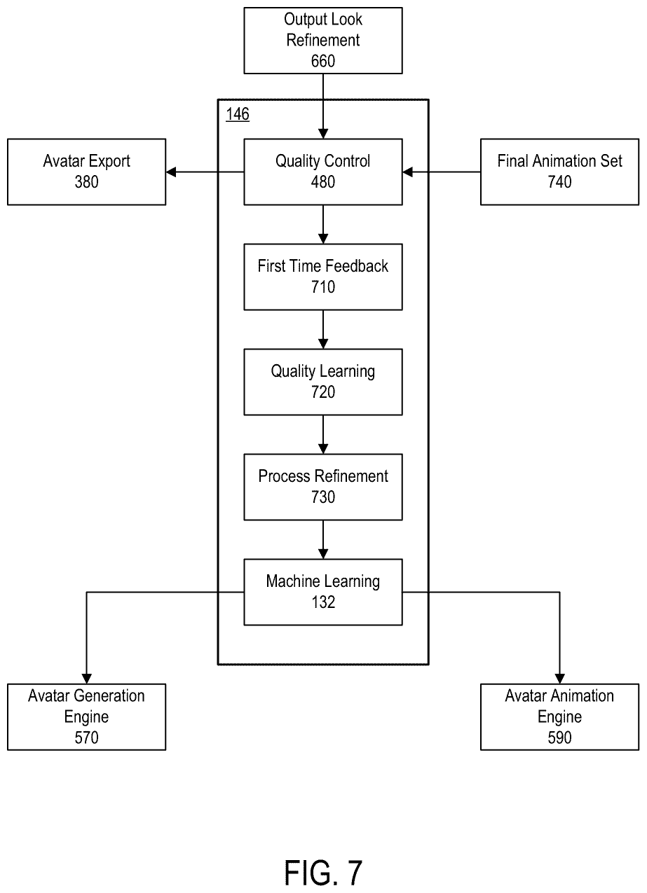

FIG. 7 is a diagram of an illustrative quality assurance and learning module 146, in accordance with example embodiments. The quality assurance and learning module 146 may be configured to check the quality of the generated avatar via quality control 480. Quality control 480 may be configured to analyze the generated avatar and provide first time feedback 710. Based on first time feedback 710, quality assurance and learning module 146 may be configured for quality learning 720. Quality assurance and learning module 146 may utilize machine learning module 132 to determine a quality based on machine learning module 132 being trained on datasets showing an avatar comparison with a user and a corresponding quality designation. The determined quality may be used to improve avatar fidelity to the user. Quality assurance and learning module 146 may be configured to provide process refinement 730 via machine learning module 132 to refine the process of capturing the user information and generating the avatar. Process refinement 730 may be configured to iteratively improve the generation of the avatar based on captured user information. Process refinement 730 may be configured to refine the training sets used for machine learning module 132 to further improve the quality of the avatar. Quality assurance and learning module 146 may be configured to apply the results of machine learning module 132 to one or more of avatar generation module 120 or avatar animation module 142.

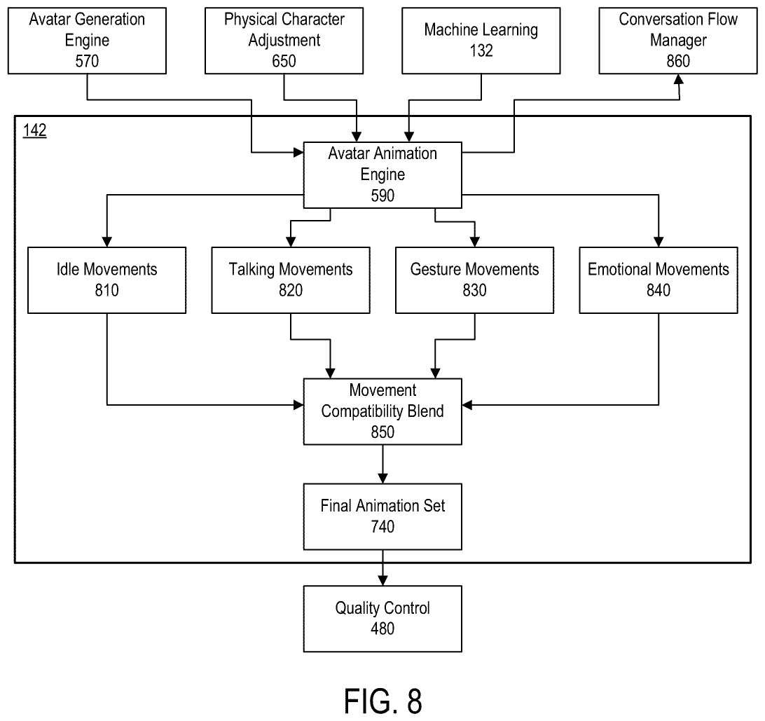

FIG. 8 is a diagram of an illustrative avatar animation module 142, in accordance with example embodiments. The avatar animation module 142 may include an avatar animation engine 590 configured to animate the avatar by selecting movements and stitching them together to provide a smooth animation. Avatar animation engine 590 may select one or more of idle movements 810, talking movements 820, gesture movements 830, or emotion movements 840. In some embodiments, the movements may be stored in memory of avatar system 118.

Idle movements 810 may include one or more movements corresponding to an idle state of the avatar. For example, idle movements 810 may include one or more of slight movements, swaying, blinking, turning the head, or such like. In some embodiments, the idle state of the avatar may be the base state, such that the avatar may return to the base state after executing an action.

Talking movements 820 movements 820 may include one or more movements corresponding to a talking state of the avatar. For example, movements 820 may include one or more of lip movements, blinking, lower face movements, or such like.

Gesture movements 830 may include one or more of hand gestures, head gestures, leg gestures, or such like. In some embodiments, one or more gesture movements 830 may correspond to one or more of specific words and/or phrases or specific emotions.

Emotion movements 840 may include one or more of facial features, body position, body language, or such like. In some embodiments, one or more emotion movements 840 may correspond to one or more of specific words and/or phrases, specific sentiments of generated speech, specific sentiments perceived in another user and/or avatar, or specific emotions.

Avatar animation module 142 may be configured to combine the one or more selected movements via movement compatibility blend 850. Movement compatibility blend 850 may be configured to receive the selected movements and blend them together with smooth transitions in a way that appears natural. In some embodiments, movement compatibility blend 850 may utilize machine learning module 132. The blended avatar may be output as the final animation set 740. Avatar animation module 142 may be configured to communicate final animation set 740 to quality control 480 of quality assurance and learning module 146.

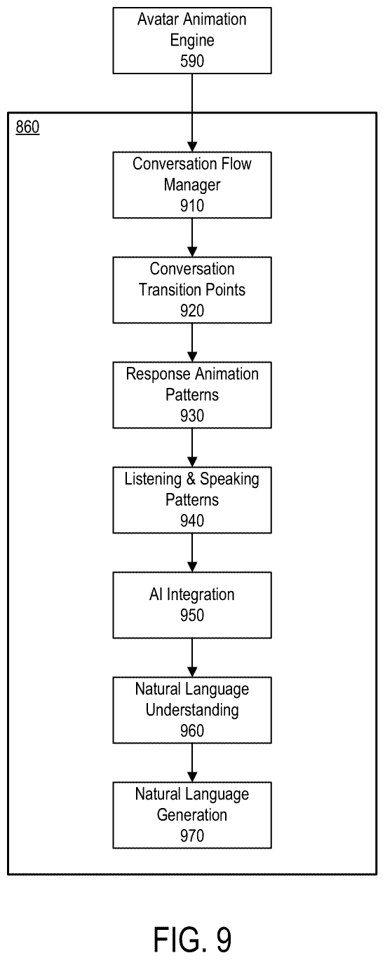

FIG. 9 is a diagram of an illustrative conversation flow management module 860, in accordance with example embodiments. The conversation flow management module 860 may include a conversation flow manager 910. Conversation flow manager 910 may be configured to manage the avatar during avatar conversations and identify one or more of conversation transition points 920, response animation patterns 930, or listening and speaking patterns 940. Machine learning module 132 may be configured to identify the patterns and transition points based on training data and data received in real-time through interactions. Thus, conversation flow management module 860 may be configured to continually learn based off previous interactions. Conversation transition points 920 may include transitions between speakers, such that conversation flow manager 910 may identify who is speaking and/or if the speaker is directing the speech to the avatar. Response animation patterns 930 may include one or more patterns for the response based on one or more characteristics of the user captured via user capture module 112. Listening and speaking patterns 940 may include one or more patterns for when to listen and when to speak based on one or more characteristics of the user captured via user capture module 112.

Conversation flow management module 860 may include AI integration 950. AI integration 950 may be configured for natural language understanding 960 and natural language generation 970. Large language model 122 may be configured to perform one or more of the natural language understanding 960 or natural language generation 970. Natural language understanding 960 may be configured to analyze sentiment and/or tone of received speech or text to understand the input in order to generate a response. Based on the sentiment of the received speech or text, natural language generation 970 may generate a response. Conversation flow management module 860 may be configured to adapt one or more expressions, tone, and/or gestures based on the sentiment in order look and sound appropriately while synthesizing the response. Conversation flow management module 860 may utilize machine learning module 132 to adapt the animation via avatar animation module 142.

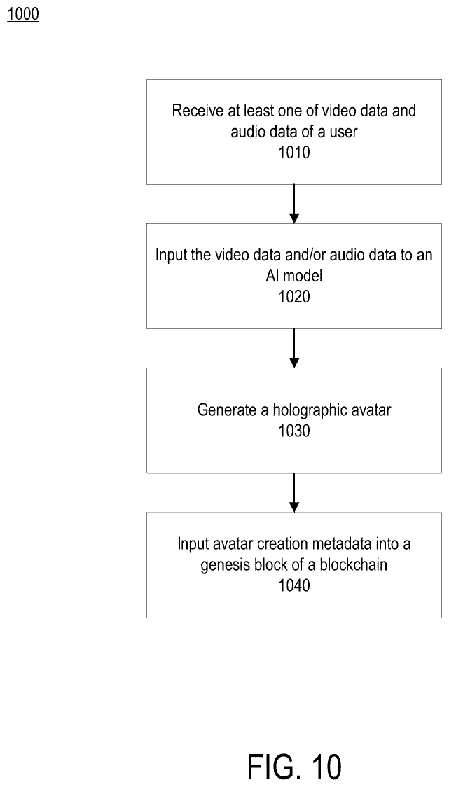

FIG. 10 is a flowchart illustrating a method 1000, according to example embodiments. Method 1000 may begin at step 1010.

At step 1010, server system 104 may receive at least one of video data or audio data of a user. Server system 104 may receive the video data and/or audio data via user capture module 112 of user device 102. In some embodiments, server system 104 may cause user capture module 112 to prompt the user to perform one or more gestures and/or emotional cues in order to capture a range of movements. In some embodiments, server system 104 may map captured expressions and gestures to one or more of sentiment or emotion. The mapped expressions and gestures may be stored in a memory in one or more of user device 102 or server system 104 to be accessible to output generation module 124.

At step 1020, server system 104 may input the video data and/or audio data to an AI model. Server system, 104 may analyze the audio data and identify one or more vocal characteristics of the audio data. Server system 104 may generate a voice for the holographic avatar based on the vocal characteristics of the audio data. Server system 104 may utilize one or more of pre-processing module 130, machine learning module 132, and/or voice generation module 134. The AI model may be configured to stitch one or more motions captured in the video data together using avatar animation module 142 to provide an avatar moving like the user. The AI model may be configured to synchronize lip movements captured in the video data with the audio data such that specific lip movements may be mapped to the user's speech to generate a realistic avatar animation. The AI model may be configured to synthesize expressions based on the video data and/or audio data such that the generated avatar may make expressions similar to the user during certain movements and/or speech.

At step 1030, server system 104 may generate a holographic avatar. Server system 104 may utilize avatar generation module 120 in generating the holographic avatar. In some embodiments, server system 104 may be configured to customize their holographic avatar by dynamically changing, for example, one or more of accessories, hair style, or clothing of the holographic avatar in real-time.

At step 1040, server system 104 may store or broadcast avatar creation metadata on or to a blockchain. Server system 104 may utilize identity verification module 136 in generating and updating the blockchain such that the blockchain may protect the avatar from unauthorized use or duplication.

In some embodiments, server system 104 may be configured to dynamically adapt one or more of the expression or tone of the avatar based on a real-time sentiment analysis of speech or text received by the computing system. For example, server system 104 may utilize large language model 122 to understand the speech or text and determine the sentiment. The expression and tone may be adapted via avatar animation module 142 based on a response generated via large language model 122.

In some embodiments, server system 104 may be configured to integrate the holographic avatar into one or more third-party platforms, wherein the integrated holographic avatar is configured to interact on the third-party platform. The one or more third-party platforms may be accessible via one or more third party servers 108. In some embodiments, the avatar may be configured to interact on a plurality of third-party platforms simultaneously. Avatar system 118 may be configured to store one or more copies of the avatar such that separate avatars may be communicated to different third-party platforms. The computing system may utilize integration module 126 for integrating the avatar.

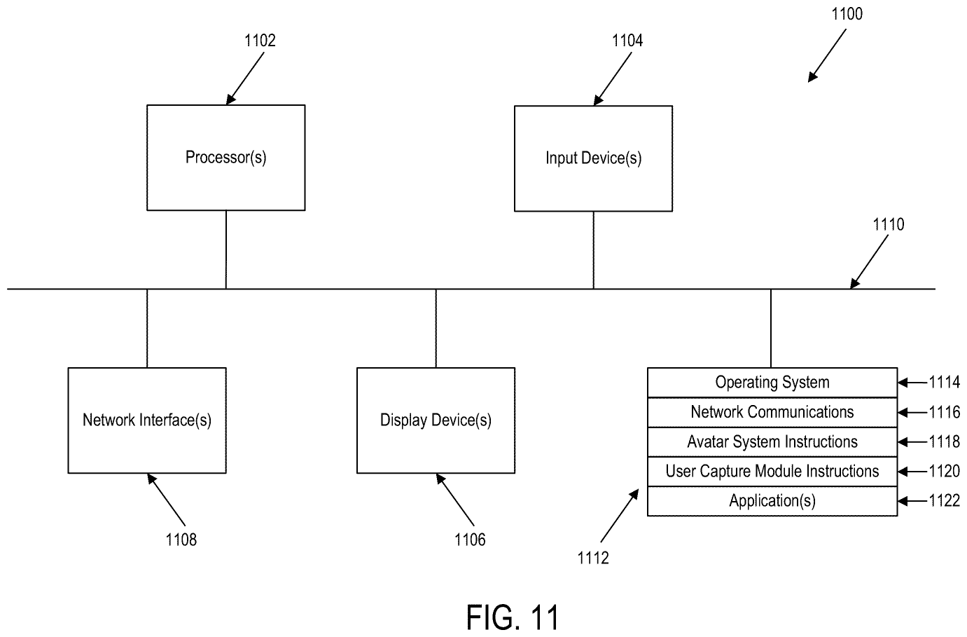

FIG. 11 shows a block diagram of an example computing device 1100 that implements various features and processes, according to example embodiments of this disclosure. For example, computing device 1100 may function as the user device 102, the server system 104, the secondary user device 106, and/or the one or more third party servers 108, or a portion or combination thereof in some embodiments. Additionally, the computing device 1100 may partially or wholly host and deploy avatar system 118. The computing device 1100 may also perform one or more steps of the method 1000. The computing device 1100 may be implemented on any electronic device that runs software applications derived from compiled instructions, including without limitation personal computers, servers, smart phones, media players, electronic tablets, game consoles, email devices, etc. In some implementations, the computing device 1100 includes one or more processors 1102, one or more input devices 1104, one or more display devices 1106, one or more network interfaces 1108, and one or more computer-readable media 1112. Each of these components may be coupled by a bus 1110.

Display device 1106 includes any display technology, including but not limited to display devices using Liquid Crystal Display (LCD) or Light Emitting Diode (LED) technology. Processor(s) 1102 uses any processor technology, including but not limited to graphics processors and multi-core processors. Input device 1104 includes any known input device technology, including but not limited to a keyboard (including a virtual keyboard), mouse, track ball, and touch-sensitive pad or display. Bus 1110 includes any internal or external bus technology, including but not limited to ISA, EISA, PCI, PCI Express, USB, Serial ATA or FireWire. Computer-readable medium 1112 includes any non-transitory computer readable medium that provides instructions to processor(s) 1102 for execution, including without limitation, non-volatile storage media (e.g., optical disks, magnetic disks, flash drives, etc.), or volatile media (e.g., SDRAM, ROM, etc.).

Computer-readable medium 1112 includes various instructions 1114 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 1104; sending output to display device 1106; keeping track of files and directories on computer-readable medium 1112; controlling peripheral devices (e.g., disk drives, printers, etc.) which can be controlled directly or through an I/O controller; and managing traffic on bus 1110. Network communications instructions 1116 establish and maintain network connections (e.g., software for implementing communication protocols, such as TCP/IP, HTTP, Ethernet, telephony, etc.).

Avatar system instructions 1118 may include instructions that implement one or more of the disclosed modules within avatar system 118, as described throughout this disclosure. User capture module instructions 1120 may include instructions that implement one or more of the disclosed modules within user capture module 112, as described throughout this disclosure. Application(s) 1122 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method, the method comprising:
receiving, via a computing system, at least one of video data and audio data of a user;
inputting, via the computing system, the video data and/or audio data to an AI model, wherein the AI model is configured to stitch one or more motions captured in the video data, synchronize lip movements captured in the video data with the audio data, and synthesize expressions based on the video data and/or audio data;
generating, by the AI model via the computing system, a holographic avatar based on the video data and/or audio data; and
storing, via the computing system, avatar creation metadata based on the generation of the holographic avatar in a block of a blockchain.

2. The method of claim 1, further comprising:
dynamically changing, via the computing system, one or more of accessories, hair style, or clothing of the holographic avatar in real-time.

3. The method of claim 1, further comprising:
analyzing, via the computing system, the audio data;
identifying, via the computing system, one or more vocal characteristics of the audio data; and
generating, via the computing system, a voice for the holographic avatar based on the vocal characteristics of the audio data.

4. The method of claim 1, further comprising:
dynamically adapting, via the computing system, one or more of the expression or tone of the avatar based on a real-time sentiment analysis of speech or text received by the computing system.

5. The method of claim 1, wherein the receiving of at least one of video data and audio data of a user is received via a mobile device.

6. The method of claim 1, further comprising:
integrating, via the computing system, the holographic avatar into one or more third-party platforms,
wherein the integrated holographic avatar is configured to interact on the third-party platform.

7. The method of claim 6, wherein the avatar is configured to interact on a plurality of third-party platforms simultaneously.

8. A system comprising:
a non-transitory storage medium storing computer program instructions; and
a processor configured to execute the computer program instructions to cause operations comprising:
receiving at least one of video data and audio data of a user;
inputting the video data and/or audio data to an AI model, wherein the AI model is configured to stitch one or more motions captured in the video data, synchronize lip movements captured in the video data with the audio data, and synthesize expressions based on the video data and/or audio data;
generating, by the AI model, a holographic avatar based on the video data and/or audio data; and
inputting avatar creation metadata based on the generation of the holographic avatar into a block of a blockchain.

9. The system of claim 8, the instructions further comprising:
dynamically changing one or more of accessories, hair style, or clothing of the holographic avatar in real-time.

10. The system of claim 8, the instructions further comprising:
analyzing the audio data;
identifying one or more vocal characteristics of the audio data; and
generating a voice for the holographic avatar based on the vocal characteristics of the audio data.

11. The system of claim 8, the instructions further comprising:
dynamically adapting one or more of the expression or tone of the avatar based on a real-time sentiment analysis of speech or text received by the computing system.

12. The system of claim 8, wherein the receiving of at least one of video data and audio data of a user is received is via a mobile device associated with the user.

13. The system of claim 8, the instructions further comprising:
integrating the holographic avatar into one or more third-party platforms,
wherein the integrated holographic avatar is configured to interact on the third-party platform.

14. The system of claim 13, wherein the avatar is configured to interact on a plurality of third-party platforms simultaneously.

15. A non-transitory storage medium storing computer program instructions that when executed causes a computing system to perform operations comprising:
receiving, via a computing system, at least one of video data and audio data of a user;
inputting, via the computing system, the video data and/or audio data to an AI model, wherein the AI model is configured to stitch one or more motions captured in the video data, synchronize lip movements captured in the video data with the audio data, and synthesize expressions based on the video data and/or audio data;
generating, by the AI model via the computing system, a holographic avatar based on the video data and/or audio data; and
inputting, via the computing system, avatar creation metadata based on the generation of the holographic avatar into a block of a blockchain.

16. The non-transitory storage medium of claim 15, the instructions further comprising:
dynamically changing, via the computing system, one or more of accessories, hair style, or clothing of the holographic avatar in real-time.

17. The non-transitory storage medium of claim 15, the instructions further comprising:
analyzing, via the computing system, the audio data;
identifying, via the computing system, one or more vocal characteristics of the audio data; and
generating, via the computing system, a voice for the holographic avatar based on the vocal characteristics of the audio data.

18. The non-transitory storage medium of claim 15, the instructions further comprising:
dynamically adapting, via the computing system, one or more of the expression or tone of the avatar based on a real-time sentiment analysis of speech or text received by the computing system.

19. The non-transitory storage medium of claim 15, wherein the receiving of at least one of video data and audio data of a user is received via a mobile device.

20. The non-transitory storage medium of claim 15, the instructions further comprising:
integrating, via the computing system, the holographic avatar into one or more third-party platforms,
wherein the integrated holographic avatar is configured to interact on the third-party platform.
